(19) United States
(12) Patent Application Publication
(10) Pub. No.: US 2025/0369193 A1
(43) Pub. Date: Dec. 4, 2025

(54) DEFORMATION ELEMENT, FORMING MOULD COMPRISING A DEFORMATION ELEMENT AND METHOD FOR FORMING CELLULOSE PRODUCTS

(71) Applicant: PULPAC AB, Västra Frölunda (SE)

(72) Inventors: Martin LJUNGBERG, Göteborg (SE); Olle HÖGBLOM, Göteborg (SE); Björn ARLEROT, Göteborg (SE); Mathias BERGFJORD, Göteborg (SE); Felix SJÖSTRAND JONSSON, Göteborg (SE); Niklas EKSTRAND, Lerum (SE)

(21) Appl. No.: 18/875,435

(22) PCT Filed: Jun. 7, 2023
(86) PCT No.: PCT/EP2023/065268

§ 371 Date: Dec. 16, 2024

(30) Foreign Application Priority Data
Jun. 17, 2022 (SE) 2250742-0

(51) Int. Cl. D21J 3/10

(52) U.S. Cl. CPC D21J 3/10

(57) ABSTRACT

A deformation element for forming three-dimensional cellulose products from an air-formed cellulose blank structure in a forming mould. The deformation element includes an ejection element arranged for ejecting the cellulose products from the deformation element after forming of the cellulose products in the forming mould. The ejection element is arranged as a protruding body extending in a pressing direction of the deformation element relative to a surrounding surface of the deformation element in a non-compressed state. The ejection element is configured for separating the formed cellulose products from the deformation element upon expansion of the deformation element and/or the ejection element from a compressed state to the non-compressed state after the forming of the cellulose products in the forming mould.

### TECHNICAL FIELD

The present disclosure relates to a deformation element for forming three-dimensional cellulose products from an air-formed cellulose blank structure in a forming mould. The disclosure further relates to a forming mould for forming three-dimensional cellulose products from an air-formed cellulose blank structure where the forming mould comprises a deformation element, and a method for forming three-dimensional cellulose products from an air-formed cellulose blank structure in a forming mould where the forming mould comprises a deformation element.

### BACKGROUND

Cellulose fibres are commonly used as raw material for producing or manufacturing products. Products formed of cellulose fibres can be used in many different situations where there is a need for sustainable products. A wide range of products can be produced from cellulose fibres and a few examples are disposable plates and cups, cutlery, lids, bottle caps, coffee pods, blank structures, and packaging materials.

Forming mould systems are commonly used when manufacturing cellulose products from raw materials including cellulose fibres, and traditionally the cellulose products have been produced by wet-forming methods. A material commonly used for wet-forming cellulose fibre products is wet moulded pulp. Wet-formed products are generally formed by immersing a suction forming mould into a liquid or semi liquid pulp suspension or slurry comprising cellulose fibres, and when suction is applied, a body of pulp is formed with the shape of the desired product by fibre deposition onto the forming mould. With all wet-forming methods, there is a need for drying of the wet moulded product, where the drying process is a time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products is dry-forming of cellulose products without using wet-forming methods. Instead of forming the cellulose products from a liquid or semi liquid pulp suspension or slurry, an air-formed cellulose blank structure is used. The air-formed cellulose blank structure is inserted into a forming mould and during the dry-forming of the cellulose products, the cellulose blank structure is subjected to a high forming pressure and a high forming temperature. One difficulty with dry-forming methods is the problem with removing the formed cellulose products from the forming mould in an efficient way, especially when using a deformation element for establishing a forming pressure in the forming mould. The formed cellulose products are easily stuck onto the deformation element in the forming mould after the forming process and therefore many times, mechanical removing devices are used for removing the cellulose products. These mechanical removal devices are costly and complex in design and construction. The removal of the cellulose products is further a time consuming and complicated operation, and there is thus a need for a more efficient and simple forming mould and method.

### SUMMARY

An object of the present disclosure is to provide a deformation element, a forming mould, and a method for forming three-dimensional cellulose products, where the previously mentioned problems are avoided. This object is at least partly achieved by the features of the independent claims. The dependent claims contain further developments of the deformation element, forming mould, and method.

The disclosure concerns a deformation element for forming three-dimensional cellulose products from an air-formed cellulose blank structure in a forming mould. The deformation element comprises an ejection element arranged for ejecting the cellulose products from the deformation element after forming of the cellulose products in the forming mould. The ejection element is arranged as a protruding body extending in a pressing direction of the deformation element relative to a surrounding surface of the deformation element in a non-compressed state. The ejection element is configured for separating the formed cellulose products from the deformation element upon expansion of the deformation element and/or the ejection element from a compressed state to the non-compressed state after the forming of the cellulose products in the forming mould.

Advantages with these features are that the formed cellulose products are efficiently removed from the deformation element and from the forming mould with the ejection element. The ejection element is preventing the formed cellulose products from being stuck onto the deformation element in the forming mould after the forming process and with the ejection element there is no need for costly and complex mechanical removing devices for removing the cellulose products. The ejection element is further providing a fast and efficient removal operation and the forming mould can be made simple in construction.

In one embodiment, the ejection element is arranged as a structural part attached to the deformation element. With this construction, the ejection element is arranged as a separate piece of material that is securely attached to the deformation element for a simple and reliable design.

In one embodiment, the ejection element is arranged as a structural part integrated in the deformation element. The ejection element is formed of the same structural piece of material as the deformation element for an alternative simple and reliable design.

In one embodiment, the ejection element is configured as a resilient protruding body extending in the pressing direction. With this configuration, the ejection element could be made of the same material as the deformation element or alternatively from a different resilient material.

In one embodiment, the ejection element is configured as a non-resilient protruding body extending in the pressing direction. With this alternative configuration, the ejection element could be made of any suitable piece of material that is rigid compared to the deformation element, such as for example steel, aluminium, or composite materials.

In embodiments, the ejection element comprises an embossing pattern configured for forming a structural pattern in the cellulose products upon forming in the forming mould. The embossing pattern is in one embodiment configured as a barcode, a QR code, or other identification code. In an alternative embodiment, the embossing pattern is configured as a logotype.

In one embodiment, the deformation element comprises a pressure equalizing cavity. The pressure equalizing cavity is aligned with the ejection element in the pressing direction, or the pressure equalizing cavity is essentially aligned with the ejection element in the pressing direction. The pressure equalizing cavity is efficiently preventing that the ejection element is exerting a higher pressure onto the cellulose blank structure than the surrounding surface of the deformation element or other parts of the deformation element, when the deformation element with the ejection element is in the compressed state upon forming of the cellulose products.

The disclosure further concerns a forming mould for forming three-dimensional cellulose products from an air-formed cellulose blank structure, where the forming mould comprises a deformation element. The deformation element comprises an ejection element arranged for ejecting the cellulose products from the deformation element after forming of the cellulose products in the forming mould. The ejection element is arranged as a protruding body extending in a pressing direction of the forming mould relative to a surrounding surface of the deformation element in a non-compressed state. The ejection element is configured for separating the formed cellulose products from the deformation element upon expansion of the deformation element and/or the ejection element from a compressed state to the non-compressed state after the forming of the cellulose products in the forming mould. Advantages with the construction of the forming mould are that the formed cellulose products are efficiently removed from the deformation element and from the forming mould with the ejection element. The ejection element is preventing the formed cellulose products from being stuck in the forming mould after the forming process. The ejection element is further providing a fast and efficient removal operation of the cellulose products from the forming mould.

In one embodiment, the ejection element is arranged as a structural part attached to the deformation element. With this construction of the forming mould, the ejection element is arranged as a separate piece of material that is securely attached to the deformation element for a simple and reliable design.

In one embodiment, the ejection element is arranged as a structural part integrated in the deformation element. With this construction of the forming mould, the ejection element is formed of the same structural piece of material as the deformation element for an alternative simple and reliable design.

In one embodiment, the ejection element is configured as a resilient protruding body extending in the pressing direction. With this configuration, the ejection element could be made of the same material as the deformation element or alternatively from a different resilient material.

In one embodiment, the ejection element is configured as a non-resilient protruding body extending in the pressing direction. With this alternative configuration, the ejection element could be made of any suitable piece of material that is rigid compared to the deformation element, such as for example steel, aluminium, or composite materials.

In one embodiment, the forming mould comprises a first mould part and a second mould part. The first mould part and the second mould part are movable relative to each other in the pressing direction and arranged to be pressed in relation to each other during forming of the cellulose products. The deformation element is attached to the first mould part. The ejection element comprises an embossing pattern and/or the second mould part comprises a mould embossing pattern. The embossing pattern and/or mould embossing pattern is configured for forming a structural pattern in the cellulose products upon forming in the forming mould.

In one embodiment, the embossing pattern and/or the mould embossing pattern is configured as a barcode, a QR code, or other identification code. In an alternative embodiment the embossing pattern and/or the mould embossing pattern is configured as a logotype.

In one embodiment, the deformation element comprises a pressure equalizing cavity configured for equalizing pressure exerted onto the cellulose blank structure by the ejection element upon forming of the cellulose products in the forming mould. The pressure equalizing cavity is aligned with the ejection element in the pressing direction, or the pressure equalizing cavity is essentially aligned with the ejection element in the pressing direction. The pressure equalizing cavity is efficiently preventing that the ejection element is exerting a higher pressure onto the cellulose blank structure than the surrounding surface of the deformation element or other parts of the deformation element, when the deformation element with the ejection element is in the compressed state upon forming of the cellulose products. In the compressed state, the pressure equalizing cavity is allowing the deformation element to deform in such a way that the pressure exerted onto the cellulose blank structure by the ejection element is lower compared to a deformation element without the pressure equalizing cavity.

The disclosure further concerns a method for forming three-dimensional cellulose products from an air-formed cellulose blank structure in a forming mould, where the forming mould comprises a deformation element. The deformation element comprises an ejection element arranged for ejecting the cellulose products from the deformation element after forming of the cellulose products in the forming mould. The ejection element is arranged as a protruding body extending in a pressing direction of the forming mould relative to a surrounding surface of the deformation element in a non-compressed state. The method comprises the step: separating the formed cellulose products from the deformation element by the ejection element upon expansion of the deformation element and/or the ejection element from a compressed state to the non-compressed state after the forming of the cellulose products in the forming mould. The method is providing a way for efficiently removing the formed cellulose products from the deformation element and from the forming mould with the ejection element. The ejection element is preventing the formed cellulose products from being stuck onto the deformation element. The expansion of the deformation element and/or the ejection element from the compressed state to the non-compressed state is enabling the ejection element to push the formed cellulose product in a direction away from the deformation element for an easy removal of the cellulose products from the deformation element and from the forming mould.

In one embodiment, the forming mould comprises a first mould part and a second mould part, where the first mould part and the second mould part are movable relative to each other in the pressing direction and arranged to be pressed in relation to each other during forming of the cellulose products. The deformation element is attached to the first mould part. The ejection element comprises an embossing pattern and/or the second mould part comprises a mould embossing pattern. The method further comprises the step: forming a structural pattern in the cellulose products with the embossing pattern and/or the mould embossing pattern upon forming in the forming mould.

In one embodiment, the embossing pattern and/or the mould embossing pattern is configured as a barcode, a QR code, or other identification code that gives a corresponding structural pattern in the final cellulose product. In an alternative embodiment, the embossing pattern and/or the mould embossing pattern is configured as a logotype that gives a corresponding structural pattern in the final cellulose product.

In one embodiment, the deformation element comprises a pressure equalizing cavity. The pressure equalizing cavity is aligned with the ejection element in the pressing direction, or the pressure equalizing cavity is essentially aligned with the ejection element in the pressing direction. The method further comprises the step: equalizing pressure exerted onto the cellulose blank structure by the ejection element upon forming of the cellulose products in the forming mould. The pressure equalizing cavity is efficiently preventing that the ejection element is exerting a higher pressure onto the cellulose blank structure than the surrounding surface of the deformation element or other parts of the deformation element, when the deformation element with the ejection element is in the compressed state. In the compressed state, the pressure equalizing cavity is allowing the deformation element to deform in such a way that the pressure exerted onto the cellulose blank structure by the ejection element is lower compared to a deformation element without the pressure equalizing cavity.

The disclosure further concerns a three-dimensional cellulose product formed from a compressed air-formed cellulose blank structure comprising loose and separated cellulose fibres. The cellulose product comprises a formed structural pattern configured as a barcode, a QR code, or other identification code. One advantage here is that the structural pattern is formed simultaneously with the cellulose product, which removes additional treatment of the product after being formed, such as labelling the product with an identification code by use of for example printing and/or attaching a sticker or the like. A further advantage is that a structural pattern arranged on the outside of the cellulose product can be used for example for the purpose to identify the cellulose product or to provide a table of content of any matter stored in the cellulose product. A structural pattern arranged on the inside of the cellulose product can be used for a second purpose, for example, to identify how the cellulose product should be recycled. With loose and separated cellulose fibres is meant cellulose fibres that are separated from each other and loosely arranged relative to each other within the cellulose blank structure, or cellulose fibres or cellulose fibre bundles that are separated from each other and loosely arranged relative to each other within the cellulose blank structure.

### BRIEF DESCRIPTION OF DRAWINGS

The disclosure will be described in detail in the following, with reference to the attached drawings, in which

FIG. 1a-c show schematically, in side views, a pressing module with a forming mould according to an embodiment,

FIG. 2a-f show schematically, in side views, a forming mould with a deformation element comprising an ejection element according to embodiments,

FIG. 3a-e show schematically, in side views, a forming mould with a deformation element comprising an ejection element according to an alternative embodiment,

FIG. 4a-b show schematically, in a side view and in a view from below, a first mould part of the forming mould with an ejection element comprising an embossing pattern,

FIG. 5a-b show schematically in a side view and in a view from above, a cellulose product with a formed structural pattern,

FIG. 6a-b show schematically, in a side view and in a view from above, a second mould part of the forming mould comprising a mould embossing pattern,

FIG. 7a-b show schematically in a side view and in a view from below, a cellulose product with a formed structural pattern, and

FIG. 8a-b show schematically in side views, a forming mould with a deformation element comprising an ejection element and a pressure equalizing cavity according to an embodiment.

### DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

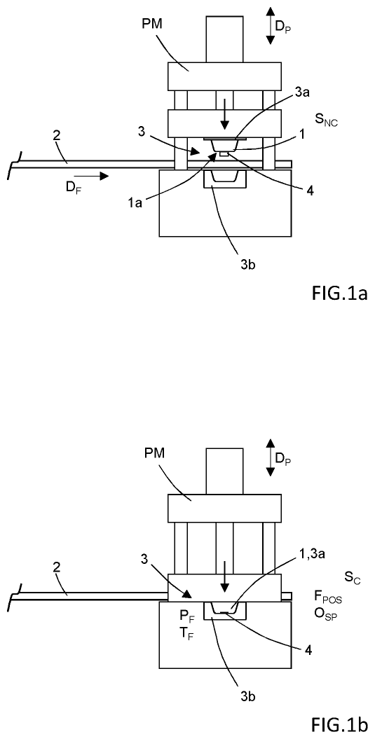

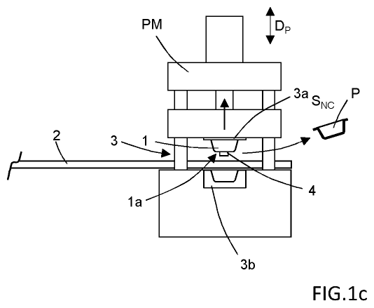

FIGS. 1a-c schematically show a pressing module PM for dry-forming cellulose products P from an air-formed cellulose blank structure 2. The pressing module PM comprises a forming mould 3 with a deformation element 1. The forming mould 3 is arranged with a first mould part 3a and a second mould part 3b configured for interacting with each other for forming the cellulose products P from the air-formed cellulose blank structure 2 in the forming mould 3. The first mould part 3a and/or the second mould part 3b are movably arranged relative to each other in a pressing direction D_{P}. In the illustrated embodiment, the deformation element 1 is attached to the first mould part 3a. The deformation element 1 comprises an ejection element 4 arranged for ejecting the cellulose products P from the deformation element 1 and from the forming mould 3, after forming of the cellulose products P in the forming mould 3.

The cellulose products P are dry-formed from the air-formed cellulose blank structure 2 in the pressing module PM. With an air-formed cellulose blank structure 2 is meant an essentially air-formed fibrous web structure produced from cellulose fibres, where the cellulose fibres are carried and formed to the cellulose blank structure 2 by air as carrying medium. The cellulose blank structure 2 comprises loose and separated cellulose fibres that are compressed upon forming of the cellulose products P. With loose and separated cellulose fibres is meant cellulose fibres that are separated from each other and loosely arranged relative to each other within the cellulose blank structure 2, or cellulose fibres or cellulose fibre bundles that are separated from each other and loosely arranged relative to each other within the cellulose blank structure 2. The cellulose fibres may originate from a suitable cellulose raw material, such as a pulp material. Suitable pulp materials are for example fluff pulp, paper structures, or other cellulose fibre containing structures. The cellulose fibres may also be extracted from agricultural waste materials, for example wheat straws, fruit and vegetable peels, bagasse, or from other suitable sources. When for example using pulp as raw material for the cellulose blank structure 2, the pulp structure commonly needs to be separated in a separating unit, such as a suitable mill unit, before the air-forming of the cellulose blank structure 2. In the separating unit, the pulp structure is separated into individual cellulose fibres, or into individual cellulose fibres and cellulose fibre bundles, and the better milling process the more individual cellulose fibres are formed. In other embodiments, only individual cellulose fibres may be used as raw material for the cellulose blank structure 2. With air-forming of the cellulose blank structure 2 is meant the formation of a cellulose blank structure in a dry and controlled fibre forming process in which the cellulose fibres are air-formed to produce the cellulose blank structure 2. When forming the cellulose blank structure 2 in the air-forming process, the cellulose fibres are carried and formed to the cellulose blank structure 2 by air as carrying medium. It should be understood that even if the cellulose blank structure 2 is slightly compacted before the forming of the cellulose products P, such as compacting the cellulose blank structure 2 for feeding or transportation purposes, the cellulose blank structure 2 still comprises loose and separated cellulose fibres.

The air-forming process for forming the cellulose blank structure 2 is different from a normal papermaking process or a traditional wet-forming process, where water is used as carrying medium for the cellulose fibres when forming the paper or fibre structure. In the air-forming process, small amounts of water or other substances may if desired be added to the cellulose fibres in order to change the properties of the cellulose products, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose products P.

The air-formed cellulose blank structure 2 may be formed of cellulose fibres in a conventional air-forming process or in a cellulose blank air-forming module. The cellulose blank structure 2 may have a composition where the fibres are of the same origin or alternatively contain a mix of two or more types of cellulose fibres, depending on the desired properties of the cellulose products P. The cellulose fibres used in the cellulose blank structure 2 are during the forming process of the cellulose products P strongly bonded to each other with hydrogen bonds, due to applied forming pressure and forming temperature together with adequate moist content in the cellulose blank structure 2. The cellulose fibres may be mixed with other substances or compounds to a certain amount. With cellulose fibres is meant any type of cellulose fibres, such as natural cellulose fibres or manufactured cellulose fibres. The cellulose blank structure 2 may specifically comprise at least 95% cellulose fibres, or more specifically at least 99% cellulose fibres.

The air-formed cellulose blank structure 2 may have a single-layer or a multi-layer configuration. A cellulose blank structure 2 having a single-layer configuration is referring to a structure that is formed of one layer containing cellulose fibres. A cellulose blank structure 2 having a multi-layer configuration is referring to a structure that is formed of two or more layers comprising cellulose fibres, where the layers may have the same or different compositions or configurations.

The cellulose blank structure 2 may comprise one or more additional cellulose layers comprising cellulose fibres, where an additional cellulose layer for example is arranged as a carrying layer for one or more other layers of the cellulose blank structure 2. The one or more additional cellulose layers may act as reinforcement layers having a higher tensile strength than other layers of the cellulose blank structure 2. This is useful when one or more air-formed layers of the cellulose blank structure 2 have compositions with low tensile strength in order to avoid that the cellulose blank structure 2 will break during the forming of the cellulose products P. The one or more additional cellulose layers with higher tensile strength act in this way as a supporting structure for other layers of the cellulose blank structure 2. The one or more additional cellulose layers may be of a different composition than the rest of the cellulose blank structure 2, such as for example a tissue layer containing cellulose fibres, an airlaid structure comprising cellulose fibres, or other suitable layer structures. It is thus not necessary that the one or more additional cellulose layers are air-formed. Other suitable additional layers may also be used such as for example silicone coated structures or bio-based films.

The one or more air-formed layers of the cellulose blank structure 2 are fluffy and airy structures, where the cellulose fibres forming the structures are arranged relatively loosely relative to each other. The fluffy cellulose blank structures 2 are used for an efficient dry-forming of the cellulose products P, allowing the cellulose fibres to form the cellulose products P in an efficient way during the dry-forming process in the pressing module PM.

FIGS. 1a-c schematically show an example embodiment of the pressing module PM for dry-forming cellulose products P from the cellulose blank structure 2. To form the cellulose products P from the air-formed cellulose blank structure 2 in the pressing module PM, the cellulose blank structure 2 is first provided from a suitable source. The cellulose blank structure 2 may be air-formed from cellulose fibres and arranged on rolls or in stacks. The rolls or stacks may thereafter be arranged in connection to the pressing module PM. As an alternative, the cellulose blank structure 2 may be air-formed from cellulose fibres in a non-illustrated cellulose blank air-forming module arranged in connection to the pressing module PM, and directly fed to the pressing module PM after the air-forming operation. The cellulose blank structure 2 is fed to the pressing module PM with suitable non-illustrated transportation means, such as forming wires, vacuum belt feeders, or conveyor belts.

The pressing module PM comprises one or more forming moulds 3, and the one or more forming moulds 3 are configured for dry-forming the cellulose products P from the cellulose blank structure 2. The pressing module PM may be arranged with only one forming mould 3 in a single-cavity configuration, or alternatively with two or more forming moulds in a multi-cavity configuration. A single-cavity configuration pressing module thus comprises only one forming mould 3 with a first mould part 3a and a cooperating second mould part 3b. A multi-cavity configuration pressing module comprises two or more forming moulds 3, each having cooperating first mould part 3a and second mould part 3b.

In the embodiment illustrated in FIGS. 1a-c, the pressing module PM is arranged as a single-cavity configuration pressing module comprising one forming mould 3 with a first mould part 3a and a second mould part 3b movably arranged relative to each other. In the following, the pressing module PM will be described in connection to a single-cavity configuration pressing module, but the disclosure is equally applicable on a multi-cavity configuration pressing module.

The pressing module PM can for example be constructed so that the first mould part 3a or the second mould part 3b is movable and arranged to move towards the other mould part during the dry-forming process, where the other mould part is stationary or non-movably arranged. In the embodiment illustrated in FIGS. 1a-c, the first mould part 3a is movably arranged and the second mould part 3b is stationary. In an alternative non-illustrated embodiment, both the first mould part 3a and the second mould part 3b are movably arranged, where the first mould part 3a and the second mould part 3b are displaced in directions towards each other during the dry-forming process. The moving mould parts may be displaced with a suitable actuator, such as a hydraulic, pneumatic, or electric actuator. A combination of different actuators may also be used. The relative speed between the first mould part 3a and the second mould part 3b during the dry-forming process is suitably chosen so that the cellulose blank structure 2 is evenly distributed in the forming mould 3 during the dry-forming process.

As indicated in FIGS. 1a-c, the first mould part 3a is movably arranged relative to the second mould part 3b in the pressing direction D_{P} and the first mould part 3a is further arranged to be pressed towards the second mould part 3b in the pressing direction D_{P} during dry-forming of the cellulose products P for establishing a forming pressure P_{F} onto the cellulose blank structure 2. When dry-forming the cellulose products P, the cellulose blank structure 2 is arranged between the first mould part 3a and the second mould part 3b when the forming mould 3 is in an open state, as shown in FIG. 1a. When the cellulose blank structure 2 has been arranged in the forming mould 3, the first mould part 3a is moved towards the second mould part 3b during the dry-forming process. When the forming pressure P_{F} together with a suitable forming temperature T_{F} are established in the forming mould 3 onto the cellulose blank structure 2, the movement of the first mould part 3a is stopped in a product forming position F_{POS}, as shown in FIG. 1b. As shown in FIG. 1c, the first mould part 3a is thereafter moved in a direction away from the second mould part 3b after a certain time duration or directly after the first mould part 3a has been stopped. A suitable control system may be used for controlling the operation of the pressing module PM and the forming mould 3.

The cellulose products P are dry-formed from the cellulose blank structure 2 in the forming mould 3 by applying the forming pressure P_{F} and a forming temperature T_{F} onto the air-formed cellulose blank structure 2. The cellulose blank structure 2 is heated to a forming temperature T_{F} in the range of 100-300° C., preferably in the range of 100-200° C., and pressed with a forming pressure P_{F} in the range of 1-100 MPa, preferably in the range of 4-20 MPa. The first mould part 3a is arranged for forming the cellulose products P through interaction with the corresponding second mould part 3b. During dry-forming of the cellulose products P, the air-formed cellulose blank structure 2 is arranged in the forming mould 3, between the first mould part 3a and the second mould part 3b, and exerted to the forming pressure P_{F} in the range of 1-100 MPa, preferably in the range of 4-20 MPa, and the forming temperature T_{F} in the range of 100-300° C., preferably in the range of 100-200° C. When dry-forming the cellulose products P, hydrogen bonds are formed between the cellulose fibres in the cellulose blank structure 2 arranged between the first mould part 3a and the second mould part 3b, due to the applied forming pressure P_{F} and forming temperature T_{F} together with adequate moist content in the cellulose blank structure 2.

The temperature and pressure levels are for example measured in the cellulose blank structure 2 during the dry-forming process with suitable sensors arranged in or in connection to the cellulose fibres in the cellulose blank structure 2. The cellulose blank structure 2 is typically containing less than 45 weight percent water when formed in the forming mould 3.

A cellulose product forming cycle is schematically illustrated in FIGS. 1a-c. The cellulose blank structure 2 is, as indicated in FIG. 1a, transported to the forming mould 3 in a feeding direction DF with a suitable transportation speed. The cellulose blank structure 2 is suitably fed intermittently to the forming mould 3. In order to form the cellulose products P, the cellulose blank structure 2 is arranged between the first mould part 3a and the second mould part 3b, as shown in FIG. 1a. Upon forming of the cellulose products P, the first mould part 3a is moved towards the second mould part 3b, and in the illustrated embodiment, the cellulose blank structure 2 is pushed by the first mould part 3a into the second mould part 3b. When the first mould part 3a is pushed towards the second mould part 3b with the cellulose blank structure 2 positioned between the mould parts, the forming pressure P_{F} is established onto the cellulose blank structure 2 by the pushing force applied by the first mould part 3a. The interaction between the first mould part 3a and the second mould part 3b is thus establishing the forming pressure P_{F} in the forming mould 3. The applied force is during the forming process establishing the forming pressure P_{F} onto the cellulose blank structure 2, as shown in FIG. 1b, which together with the forming temperature T_{F} applied onto the cellulose blank structure 2 is dry-forming the cellulose products P.

Suitably, the forming pressure P_{F} is applied onto the air-formed cellulose blank structure 2 during a single pressing operation O_{SP} upon forming of the cellulose products P in the forming mould 3. With a single pressing operation O_{SP} is meant that the cellulose product P is formed from the cellulose blank structure 2 in one single pressing step in the forming mould 3. In the single pressing operation O_{SP}, the first mould part 3a and the second mould part 3b are interacting with each other for establishing the forming pressure P_{F} and the forming temperature T_{F} during a single operational engagement step. Thus, in the single pressing operation O_{SP}, the forming pressure P_{F} and the forming temperature T_{F} are not applied to the cellulose blank structure 2 in two or more repeated pressing steps.

When the cellulose products have been dry-formed in the forming mould 3, the first mould part 3a is moved away from the second mould part 3b, as shown in FIG. 1c, and the formed cellulose product P can be removed from the forming mould 3 with the ejection element 4, as will be further described below. After removal of the cellulose product P, the cellulose product forming cycle is repeated.

As described above, the forming mould 3 comprises the deformation element 1, which is attached to the first mould part 3a. The deformation element 1 is used when forming the forming three-dimensional cellulose products P from the air-formed cellulose blank structure 2 in the forming mould 3. The deformation element 1 comprises the ejection element 4, and the ejection element 4 is arranged for ejecting the cellulose products P from the deformation element 1 and from the forming mould 3, after forming of the cellulose products P in the forming mould 3.

The deformation element 1 with the ejection element 4 is configured for exerting the forming pressure P_{F} onto the cellulose blank structure 2 during dry-forming of the cellulose products P in the forming mould. The deformation element 1 may be attached with suitable attachment means to the first mould part 3a, such as for example glue or mechanical fastening members.

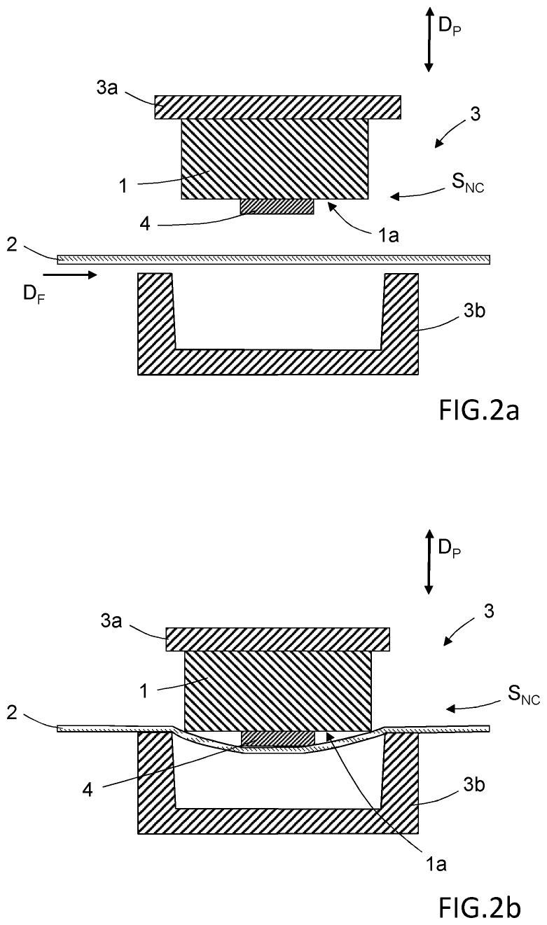

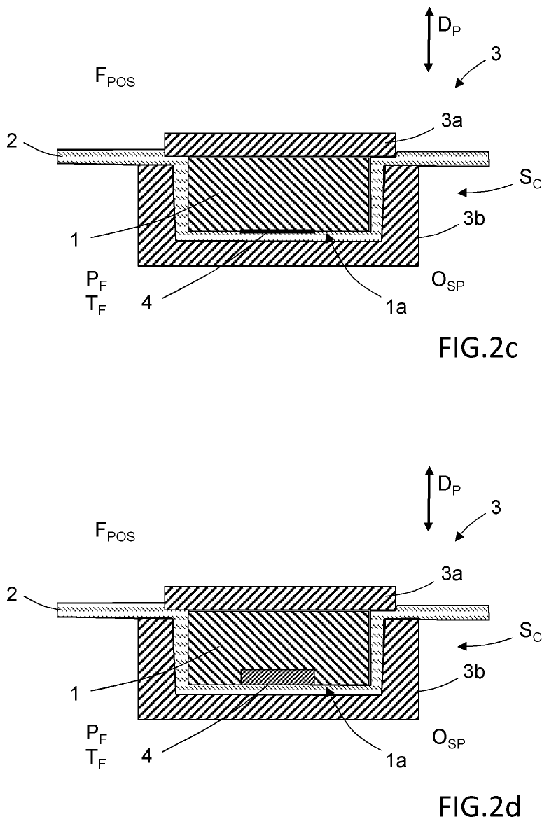

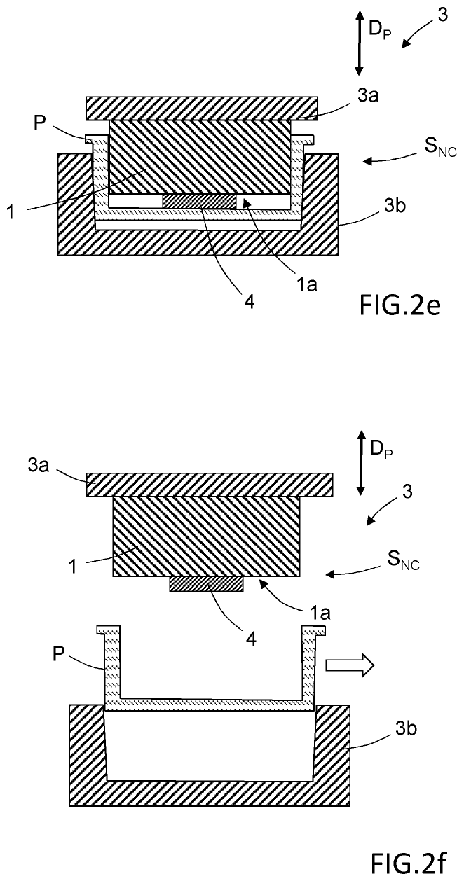

In the embodiments illustrated in FIGS. 2a-f, the ejection element 4 is arranged as a structural part attached to the deformation element 1. The ejection element 4 is arranged as a separate piece of material that is securely attached to the deformation element 1. The ejection element 4 may be configured as a resilient protruding body extending in the pressing direction D_{P}. With such a configuration, the ejection element 4 could be made of the same material as the deformation element 1 or alternatively from a different resilient material. The ejection element 4 may alternatively be configured as a non-resilient protruding body extending in the pressing direction D_{P}. With such a configuration, the ejection element 4 could be made of any suitable piece of material that is rigid compared to the deformation element, such as for example steel, aluminium, or composite materials.

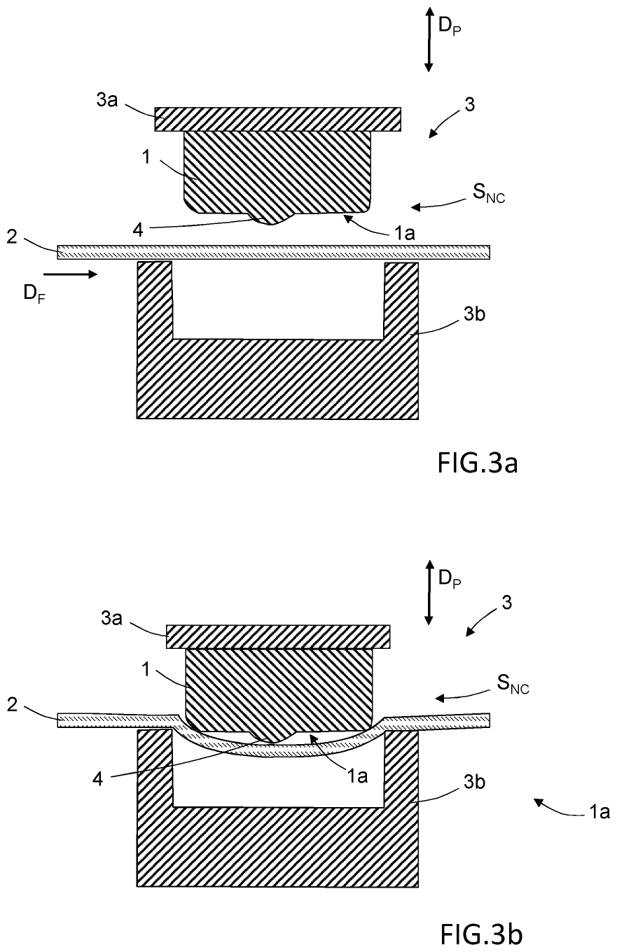

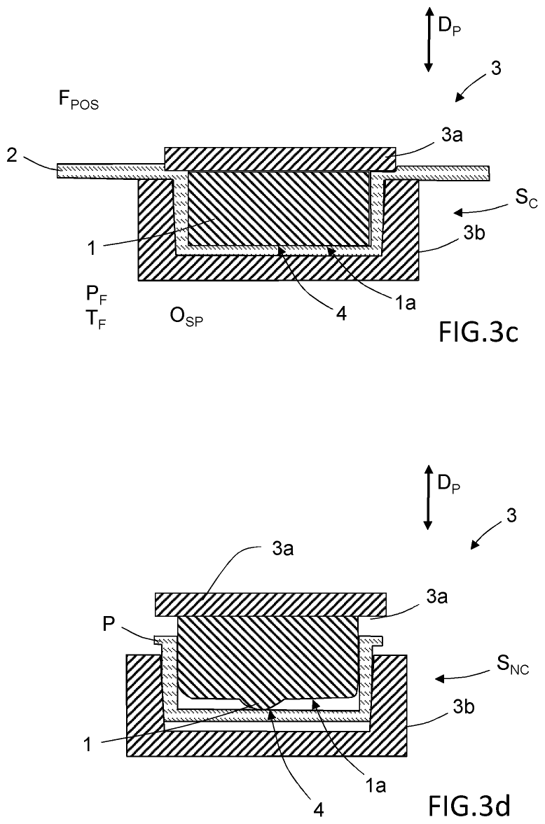

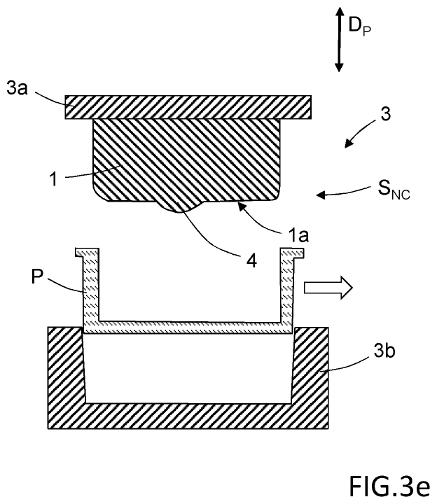

In the embodiment illustrated in FIGS. 3a-e, the ejection element 4 is arranged as a structural part integrated in the deformation element 1. The ejection element 4 is in this embodiment formed of the same structural piece of material as the deformation element 1, and the ejection element 4 is configured as a resilient protruding body extending in the pressing direction D_{P}.

In the following, different embodiments of the cellulose product forming cycle is described with reference to FIGS. 2a-f and 3a-e, which are schematically illustrating embodiments of the cellulose product forming cycle more in detail. The cellulose blank structure 2 is, as indicated in FIGS. 2a and 3a, transported to the forming mould 3 in a feeding direction DF. The cellulose blank structure 2 is suitably fed intermittently to the forming mould 3. In order to form the cellulose products P, the cellulose blank structure 2 is arranged between the first mould part 3a and the second mould part 3b, as shown in FIGS. 2a and 3a.

Upon forming of the cellulose products P, the first mould part 3a is moved towards the second mould part 3b, as shown in FIGS. 2b and 3b, and in the illustrated embodiments, the cellulose blank structure 2 is pushed by the deformation element 1 with the ejection element 4 into the second mould part 3b. When the first mould part 3a is pushed towards the second mould part 3b with the cellulose blank structure 2 positioned between the mould parts, the forming pressure P_{F} is established onto the cellulose blank structure 2 by the pushing force applied by the first mould part 3a comprising the deformation element 1.

Before any forming pressure P_{F} is exerted by the deformation element 1 onto the cellulose blank structure 2, the deformation element 1 is arranged in a non-compressed state S_{NC}, as schematically illustrated in FIGS. 2a and 3a. In the non-compressed state S_{NC}, the ejection element 4 is arranged as a protruding body extending in the pressing direction D_{P} of the deformation element 1 relative to a surrounding surface 1a of the deformation element 1, as understood from the figures.

During the forming of the cellulose products P, the deformation element 1 is deformed into a compressed state S_{C} to at least partly exert the forming pressure P_{F} on the cellulose blank structure 2 in the forming mould 3, and through the deformation of the deformation element 1 in the compressed state S_{C}, an even pressure distribution is achieved in the forming mould 3 even if the cellulose products P are having complex three-dimensional shapes. When the cellulose blank structure 2 has been arranged in the forming mould 3, the first mould part 3a is moved towards the second mould part 3b during the dry-forming process, as described above in connection to FIGS. 2b and 3b. When the forming pressure P_{F} is established in the forming mould 3 onto the cellulose blank structure 2, the movement of the first mould part 3a is stopped in the product forming position F_{POS}, in which the deformation element 1 is deformed into the compressed state S_{C} to at least partly exert the forming pressure P_{F} on the cellulose blank structure 2. The forming position F_{POS} is schematically shown for the different embodiments in FIGS. 2c, 2d and 3c. The interaction between the first mould part 3a with the deformation element 1 and the second mould part 3b is thus establishing the forming pressure P_{F} in the forming mould 3. The applied force is during the forming process establishing the forming pressure P_{F} onto the cellulose blank structure 2, which together with the forming temperature T_{F} applied onto the cellulose blank structure 2 is dry-forming the cellulose products P.

Suitably, the forming pressure P_{F} is applied onto the air-formed cellulose blank structure 2 during a single pressing operation O_{SP} upon forming of the cellulose products P in the forming mould 3, where the cellulose product P is formed from the cellulose blank structure 2 in one single pressing step in the forming mould 3. In the single pressing operation O_{SP}, the first mould part 3a with the deformation element 1 and the second mould part 3b are interacting with each other for establishing the forming pressure P_{F} and the forming temperature T_{F} during a single operational engagement step. Thus, in the single pressing operation O_{SP}, the forming pressure P_{F} and the forming temperature T_{F} are not applied to the cellulose blank structure 2 in two or more repeated pressing steps.

After dry-forming the cellulose products P in the forming position F_{POS}, as shown in FIGS. 2c, 2d and 3c, the first mould part 3a is moved in a direction away from the second mould part 3b. During this movement, the deformation element 1 is expanded from the compressed state S_{C} back to the non-compressed state S_{NC} after the forming of the cellulose products P in the forming mould 3, and through the expansion of the deformation element 1, the ejection element 4 is separating the formed cellulose products P from the deformation element 1 and from the forming mould 3, as shown in FIGS. 2e and 3d. The expansion of the deformation element 1 from the compressed state S_{C} back to the non-compressed state S_{NC} is enabling the ejection element 4 to push the formed cellulose product P in a direction away from the deformation element 1 for an easy removal of the cellulose products P from the deformation element 1 and from the forming mould 3, as indicated with the arrow in FIGS. 2f and 3e.

To exert a required forming pressure P_{F} on the cellulose blank structure 2, the deformation element 1 is made of a material that can be deformed when a force or pressure is applied, and the deformation element 1 is suitably made of an elastic material capable of recovering size and shape after deformation. In this way, the deformation element 1 can expand from the compressed state S_{C} back to the non-compressed state S_{NC} after the forming operation. The deformation element 1 may further be made of a material with suitable properties that is withstanding the high forming pressure P_{F} and forming temperature T_{F} levels used in the forming mould 3 when forming the cellulose products P. Certain elastic or deformable materials have fluid-like properties when being exposed to high pressure levels. If the deformation element 1 is made of such a material, an even pressure distribution can be achieved in the forming process, where the pressure exerted onto the cellulose blank structure 2 from the deformation element is equal or essentially equal in all directions. When the deformation element 1 under pressure is in its fluid-like state, a uniform fluid-like pressure distribution is achieved. The forming pressure P_{F} is with such a material thus applied to the cellulose blank structure 2 from all directions, and the deformation element 1 may exert an isostatic forming pressure on the cellulose blank structure 2 during the dry-forming of the cellulose products P.

The deformation element 1 may be made of a suitable structure of elastomeric material or materials, and as an example, the deformation element may be made of a massive structure or an essentially massive structure of silicone rubber, polyurethane, polychloroprene, or rubber with a hardness in the range 20-90 Shore A. Other materials for the deformation element 1 may for example be suitable gel materials, liquid crystal elastomers, and MR fluids. Instead of using a single deformation element structure, a plurality of deformation element structures may be used.

When the ejection element 4 is configured as a resilient protruding body extending in the pressing direction D_{P}, the ejection element 4 is configured for separating the formed cellulose products P from the deformation element 1 and from the forming mould 3 upon expansion of the deformation element 1 and the ejection element 4. During the forming of the cellulose products P in the product forming position F_{POS}, the deformation element 1 and the resilient ejection element 4 are deformed into a compressed state Sc_{C} The ejection element 4 may also be used for exerting the forming pressure P_{F} onto at least a part of the cellulose blank structure 2 in the forming mould 3. Before any forming pressure P_{F} is exerted onto the cellulose blank structure 2, the deformation element 1 and the ejection element 4 are arranged in a non-compressed state S_{NC}, as for example schematically illustrated in FIGS. 2a and 3a. In the non-compressed state S_{NC}, the ejection element 4 is arranged as a protruding body extending in the pressing direction D_{P} of the deformation element 1 relative to a surrounding surface 1a of the deformation element 1. After the forming of the cellulose products P in the forming position F_{POS}, the first mould part 3a is moved in a direction away from the second mould part 3b. During this movement, the deformation element 1 and the ejection element 4 are expanded from the compressed state S_{C} back to the non-compressed state S_{NC} after the forming of the cellulose products P in the forming mould 3, and through the expansion of the deformation element 1 and the ejection element 4, the ejection element 4 is separating the formed cellulose products P from the deformation element 1 and from the forming mould 3. The expansion of the deformation element 1 from the compressed state S_{C} back to the non-compressed state S_{NC} together with the expansion of the ejection element 4 from the compressed state S_{C} back to the non-compressed state S_{NC} are enabling the ejection element 4 to push the formed cellulose product P in a direction away from the deformation element 1 for an easy removal of the cellulose products P from the deformation element 1 and from the forming mould 3.

The ejection element 4 illustrated in FIGS. 2a-b and 2e-f may be configured as a resilient protruding body. When the ejection element 4 is configured as a resilient protruding body, the forming position F_{POS} is schematically illustrated in FIG. 2c. As understood from FIG. 2c, the deformation element 1 and the resilient ejection element 4 are deformed into a compressed state S_{C} during the forming of the cellulose products P in the product forming position F_{POS}.

The ejection element 4 illustrated in FIGS. 3a-e is configured as a resilient protruding body, and the forming position F_{POS} is illustrated in FIG. 3c. As understood from FIG. 3c, the deformation element 1 and the resilient ejection element 4 are deformed into a compressed state S_{C} during the forming of the cellulose products P in the product forming position F_{POS}.

When the ejection element 4 is configured as a non-resilient protruding body extending in the pressing direction D_{P}, the ejection element 4 is configured for separating the formed cellulose products P from the deformation element 1 and from the forming mould 3 upon expansion of the deformation element 1. During the forming of the cellulose products P in the product forming position F_{POS}, the deformation element 1 is deformed into a compressed state S_{C}. The ejection element 4 may also be used for exerting the forming pressure P_{F} onto at least a part of the cellulose blank structure 2 in the forming mould 3. Before any forming pressure P_{F} is exerted onto the cellulose blank structure 2, the deformation element 1 is arranged in a non-compressed state S_{NC}, as schematically illustrated in FIG. 2a. In the non-compressed state S_{NC}, the ejection element 4 is arranged as a protruding body extending in the pressing direction D_{P} of the deformation element 1 relative to a surrounding surface 1a of the deformation element 1. After the forming of the cellulose products P in the forming position F_{POS}, the first mould part 3a is moved in a direction away from the second mould part 3b. During this movement, the deformation element 1 is expanded from the compressed state S_{C} back to the non-compressed state S_{NC} after the forming of the cellulose products P in the forming mould 3, and through the expansion of the deformation element 1, the ejection element 4 is separating the formed cellulose products P from the deformation element 1 and from the forming mould 3. The expansion of the deformation element 1 from the compressed state S_{C} back to the non-compressed state S_{NC} is enabling the ejection element 4 to push the formed cellulose product P in a direction away from the deformation element 1 for an easy removal of the cellulose products P from the deformation element 1 and from the forming mould 3.

The ejection element 4 illustrated in FIGS. 2a-b and 2e-f may be configured as a non-resilient protruding body. When the ejection element 4 is configured as a non-resilient protruding body, the forming position F_{POS} is schematically illustrated in FIG. 2d. As understood from FIG. 2d, the deformation element 1 is deformed into a compressed state S_{C} during the forming of the cellulose products P in the product forming position F_{POS}, and the ejection element 4 is pushed into the deformation element 1 in the forming position F_{POS}.

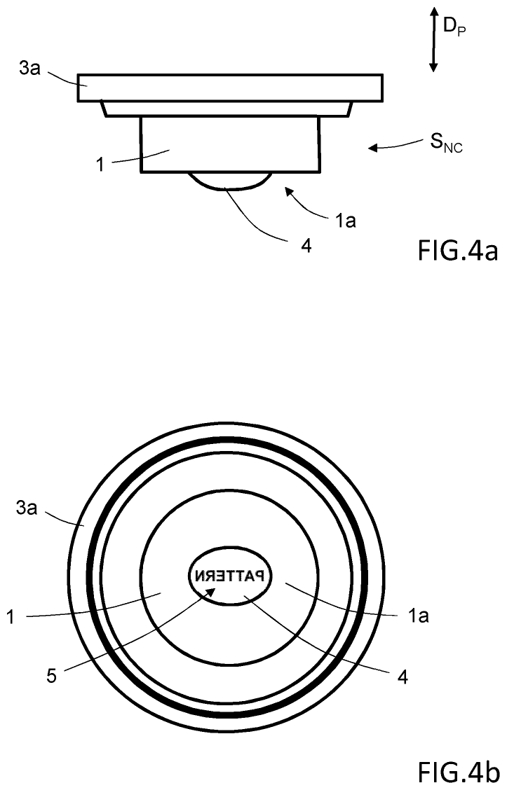

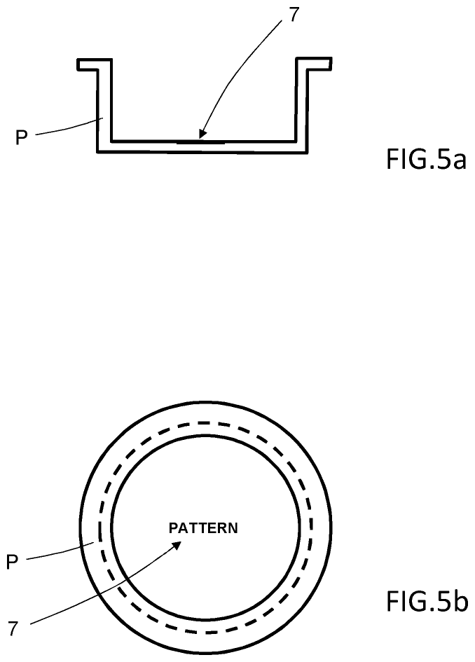

In another embodiment, as illustrated in FIGS. 4a-b, the ejection element 4 comprises an embossing pattern 5 configured for forming a structural pattern 7 in the cellulose products P upon forming in the forming mould 3. The structural pattern 7 is arranged inside the cellulose product P as schematically illustrated in FIGS. 5a-b. The embossing pattern 5 is compressing the cellulose fibres in the cellulose blank structure 2 upon forming in the forming mould 3, and the compression of the cellulose fibres are forming the structural pattern 7. The embossing pattern 5 is suitably configured as a barcode, a QR code, or other identification code, or alternatively as a logotype. The ejection element 4 may have any of the different configurations described above, such as the embodiments described in connection to FIGS. 2a-f and 3a-e.

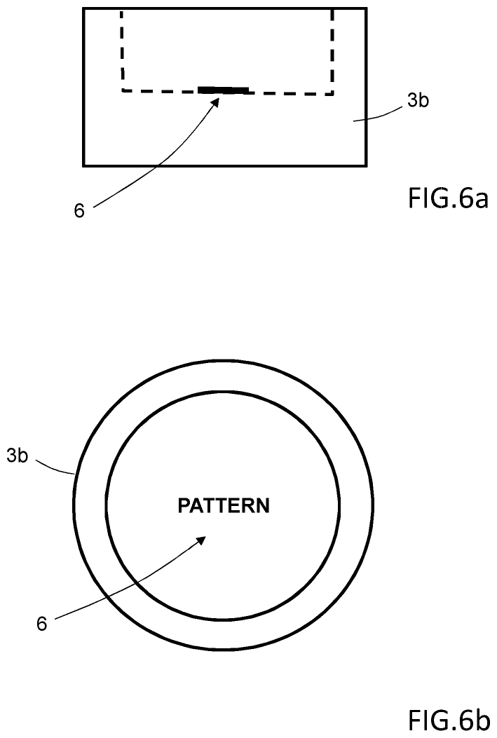

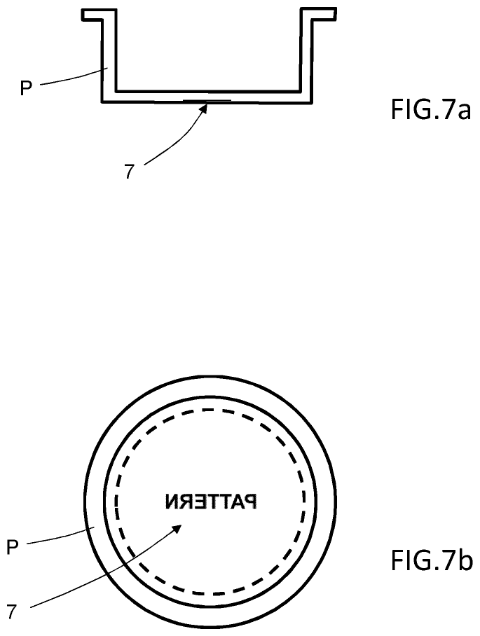

In another embodiment, as illustrated in FIGS. 6a-b, the second mould part 3b comprises a mould embossing pattern 6. The mould embossing pattern 6 is configured for forming the structural pattern 7 in the cellulose products P upon forming in the forming mould 3. The structural pattern 7 is arranged on the outside of the cellulose product P as schematically illustrated in FIGS. 7a-b. The mould embossing pattern 6 is compressing the cellulose fibres in the cellulose blank structure 2 upon forming in the forming mould 3, and the compression of the cellulose fibres are forming the structural pattern 7. The mould embossing pattern 6 is suitably configured as a barcode, a QR code, or other identification code, or alternatively as a logotype.

In other embodiments, the embossing pattern 5 and the mould embossing pattern 6 may be arranged in the same forming mould 3 for forming the structural pattern 7 on different sides of the cellulose product P.

For all embodiments, the forming mould 3 suitably comprises a heating unit that is establishing the forming temperature T_{F} in the cellulose blank structure 2. The heating unit may have any suitable configuration, and as an example, a heated mould part or heated mould parts may be used for establishing the forming temperature T_{F}. The heating unit may be integrated in or cast into the first mould part 3a and/or the second mould part 3b, and suitable heating devices are e.g. electrical heaters, such as a resistor element, or fluid heaters. Other suitable heat sources may also be used.

For all embodiments, the cellulose blank structure 2 may be arranged into the forming mould 3 in any suitable way, and as an example, the cellulose blank structure 2 may be fed with a suitable feeding device, which is transporting the cellulose blank structure 2 to the forming mould 3 in the feeding direction DF. The feeding device could for example be a conveyor belt, a forming wire unit, an industrial robot, or any other suitable manufacturing equipment. The transportation speed may differ depending on the types of cellulose products P produced, and is chosen to match the forming speed in the forming mould 3.

In other non-illustrated embodiments, the deformation element 1 may comprise two or more ejection elements 4, where each ejection element 4 may have the configurations described above, such as the embodiments illustrated in connection to FIGS. 2a-f and 3a-e.

FIGS. 5a-b and 7a-b schematically show three-dimensional cellulose products P formed from a compressed air-formed cellulose blank structure 2. The cellulose blank structure 2 comprises loose and separated cellulose fibres that are compressed upon forming of the cellulose product P. In the illustrated embodiments, the cellulose products P comprise a structural pattern 7 configured as a barcode, a QR code, or other identification code. As described above, with the expression loose and separated cellulose fibres is meant cellulose fibres that are separated from each other and loosely arranged relative to each other within the cellulose blank structure 2, or cellulose fibres or cellulose fibre bundles that are separated from each other and loosely arranged relative to each other within the cellulose blank structure 2.

As understood from FIGS. 4a-b and 5a-b, the structural pattern 7 is provided on an inside of the cellulose products P and is a result of the embossing pattern 5 in the ejection element 4 pressing against and forming the loose and separated fibres of the cellulose blank structure 2 into a rigid structure simultaneously with the forming of the cellulose products P.

As understood from FIGS. 6a-b and 7a-b, the structural pattern 7 is provided on an outside of the cellulose products P and is a result of the mould embossing pattern 6 in the second mould part 3b pressing against and forming the loose and separated fibres of the cellulose blank structure 2 into a rigid structure simultaneously with the forming of the cellulose products P.

Hence, the structural pattern 7 can be arranged on the inside of the cellulose products P or on the outside of the cellulose products P. However, according to one example embodiment, both the ejection element 4 and the second mould part 3b may be provided with embossing pattern 5 and mould embossing pattern 6 giving a structural pattern on both the inside and the outside of the product P. The two structural patterns 7 can be either two different patterns or one pattern seen from either the inside or the outside of the product P. Two different patterns can for example be advantageously used to identify two different use modes of the final product. The first use mode could for example be used to identify product specific information from the outside before use, and the second use mode could for example be used to give product specific information after use. The product specific information in the first mode could, for example, give information on what the cellulose product contains, such as a table of contents. The product specific information in the second mode could for example give information on how the cellulose product should be recycled. The structural pattern or patterns are advantageously formed such that a non-illustrated reading unit can identify the pattern and provide adequate information from for example a database to a user of the cellulose products P, or alternatively to a sorting unit or the like. The reading unit may for example be a cellular phone with a suitable sensor equipment, a handheld reader with a suitable sensor equipment, or an automized machine with a suitable sensor equipment. The suitable sensor equipment can for example be a camera connected to an image decoding device and/or a therefor adapted software for signal processing. The suitable sensor equipment can for example be a light unit connected to a frequency decoding device and/or a therefor adapted software for signal processing.

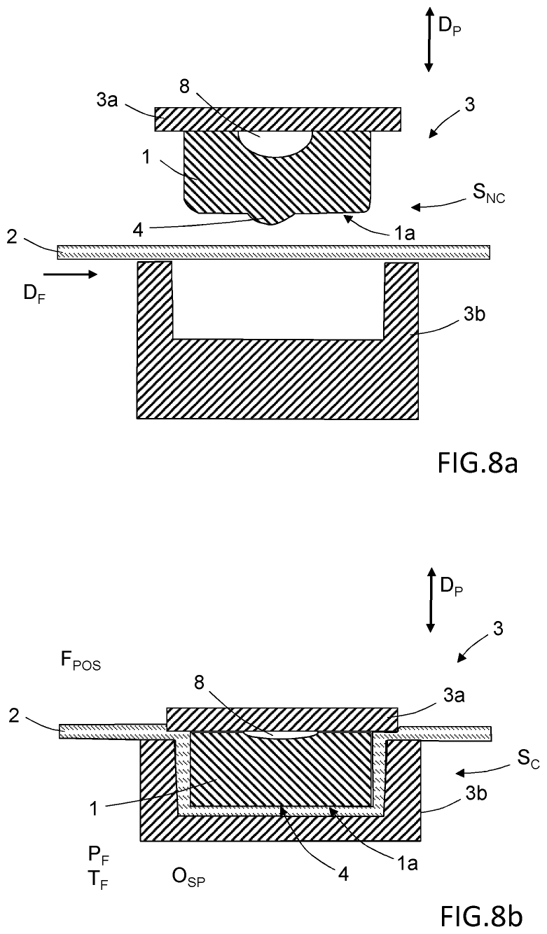

In other embodiments, the deformation element 1 comprises a pressure equalizing cavity 8. Such a configuration of the deformation element 1 is schematically illustrated in FIGS. 8a-b. The pressure equalizing cavity 8 is aligned with the ejection element 4 in the pressing direction D_{P}, or the pressure equalizing cavity 8 is essentially aligned with the ejection element 4 in the pressing direction D_{P}. The pressure equalizing cavity 8 is configured for equalizing pressure exerted onto the cellulose blank structure 2 by the ejection element 4 upon forming of the cellulose products P in the forming mould 3. The ejection element 4 is, as described above, arranged as a protruding body that is extending in the pressing direction D_{P} of the deformation element 1 relative to a surrounding surface 1a of the deformation element 1 in the non-compressed state S_{NC}, as shown in FIG. 8a. The pressure equalizing cavity 8 is preventing that the ejection element 4 is exerting a higher pressure onto the cellulose blank structure 2 than the surrounding surface 1a of the deformation element 1 or other parts of the deformation element 1, when the deformation element 1 with the ejection element 4 is in the compressed state S_{C} upon forming of the cellulose products P. In the compressed state S_{C}, as shown in FIG. 8b, the pressure equalizing cavity 8 is allowing the deformation element 1 to deform in such a way that the pressure exerted onto the cellulose blank structure 2 by the ejection element 4 is lower compared to a deformation element 1 without the pressure equalizing cavity 8. In the compressed state S_{C}, the volume of the pressure equalizing cavity 8 is lower due to the deformation of the deformation element 1, as schematically illustrated in FIGS. 8a-b. Without the pressure equalizing cavity 8, there is thus a risk that the ejection element 4 is exerting a higher pressure onto the cellulose blank structure 2 than the surrounding surface 1a of the deformation element 1 or other parts of the deformation element 1.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Deformation element
1a: Surrounding surface
2: Cellulose blank structure
3: Forming mould
3a: First mould part
3b: Second mould part
4: Ejection element
5: Embossing pattern
6: Mould embossing pattern
7: Structural pattern
8: Pressure equalizing cavity
D_{P}: Pressing direction
F_{POS}: Forming position
O_{SP}: Single pressing operation
P: Cellulose products
PM: Pressing module
P_{F}: Forming pressure
T_{F}: Forming temperature
S_{C}: Compressed state
S_{NC}: Non-compressed state

1. A deformation element for forming three-dimensional cellulose products from an air-formed cellulose blank structure in a forming mould,
wherein the deformation element comprises an ejection element arranged for ejecting the cellulose products from the deformation element after forming of the cellulose products in the forming mould,
wherein the ejection element is arranged as a protruding body extending in a pressing direction of the deformation element relative to a surrounding surface of the deformation element in a non-compressed state, wherein the ejection element is configured for separating the formed cellulose products from the deformation element upon expansion of the deformation element and/or the ejection element from a compressed state to the non-compressed state after the forming of the cellulose products in the forming mould.

2. The deformation element according to claim 1,
wherein the ejection element is arranged as a structural part attached to the deformation element.

3. The deformation element according to claim 1,
wherein the ejection element is arranged as a structural part integrated in the deformation element.

4. The deformation element according to claim 1,
wherein the ejection element is configured as a resilient protruding body extending in the pressing direction.

5. The deformation element according to claim 1,
wherein the ejection element is configured as a non-resilient protruding body extending in the pressing direction.

6. The deformation element according to claim 1,
wherein the ejection element comprises an embossing pattern configured for forming a structural pattern in the cellulose products upon forming in the forming mould.

7. The deformation element according to claim 6,
wherein the embossing pattern is configured as a barcode, a QR code, or other identification code.

8. (canceled)

9. The deformation element according to claim 1,
wherein the deformation element comprises a pressure equalizing cavity, wherein the pressure equalizing cavity is aligned with the ejection element in the pressing direction, or wherein the pressure equalizing cavity is essentially aligned with the ejection element in the pressing direction.

10. A forming mould for forming three-dimensional cellulose products from an air-formed cellulose blank structure, wherein the forming mould comprises a deformation element, wherein the deformation element comprises an ejection element arranged for ejecting the cellulose products from the deformation element after forming of the cellulose products in the forming mould,
wherein the ejection element is arranged as a protruding body extending in a pressing direction of the forming mould relative to a surrounding surface of the deformation element in a non-compressed state, wherein the ejection element is configured for separating the formed cellulose products from the deformation element upon expansion of the deformation element and/or the ejection element from a compressed state to the non-compressed state after the forming of the cellulose products in the forming mould.

11. The forming mould according to claim 10,
wherein the ejection element is arranged as a structural part attached to the deformation element.

12. The forming mould according to claim 10,
wherein the ejection element is arranged as a structural part integrated in the deformation element.

13. The forming mould according to claim 10,
wherein the ejection element is configured as a resilient protruding body extending in the pressing direction.

14. The forming mould according to claim 10,
wherein the ejection element is configured as a non-resilient protruding body extending in the pressing direction.

15. The forming mould according to claim 10,
wherein the forming mould comprises a first mould part and a second mould part, wherein the first mould part and the second mould part are movable relative to each other in the pressing direction and arranged to be pressed in relation to each other during forming of the cellulose products, wherein the deformation element is attached to the first mould part, wherein the ejection element comprises an embossing pattern and/or wherein the second mould part comprises a mould embossing pattern, wherein the embossing pattern and/or mould embossing pattern is configured for forming a structural pattern in the cellulose products upon forming in the forming mould.

16. The forming mould according to claim 15,
wherein the embossing pattern and/or the mould embossing pattern is configured as a barcode, a QR code, or other identification code.

17. (canceled)

18. The forming mould according to claim 10,
wherein the deformation element comprises a pressure equalizing cavity configured for equalizing pressure exerted onto the cellulose blank structure by the ejection element upon forming of the cellulose products in the forming mould, wherein the pressure equalizing cavity is aligned with the ejection element in the pressing direction, or wherein the pressure equalizing cavity is essentially aligned with the ejection element in the pressing direction.

19. A method for forming three-dimensional cellulose products from an air-formed cellulose blank structure in a forming mould, wherein the forming mould comprises a deformation element, wherein the deformation element comprises an ejection element arranged for ejecting the cellulose products from the deformation element after forming of the cellulose products in the forming mould, wherein the ejection element is arranged as a protruding body extending in a pressing direction of the forming mould relative to a surrounding surface of the deformation element in a non-compressed state, wherein the method comprises the step:
separating the formed cellulose products from the deformation element by the ejection element upon expansion of the deformation element and/or the ejection element from a compressed state to the non-compressed state after the forming of the cellulose products in the forming mould.

20. The method according to claim 19,
wherein the forming mould comprises a first mould part and a second mould part, wherein the first mould part and the second mould part are movable relative to each other in the pressing direction and arranged to be pressed in relation to each other during forming of the cellulose products, wherein the deformation element is attached to the first mould part, wherein the ejection element comprises an embossing pattern and/or wherein the second mould part comprises a mould embossing pattern, wherein the method further comprises the step: forming a structural pattern in the cellulose products with the embossing pattern and/or the mould embossing pattern upon forming in the forming mould.

21. The method according to claim 20,
wherein the embossing pattern and/or the mould embossing pattern is configured as a barcode, a QR code, or other identification code.

22. (canceled)

23. The method according to claim 19,
wherein the deformation element comprises a pressure equalizing cavity, wherein the pressure equalizing cavity is aligned with the ejection element in the pressing direction, or wherein the pressure equalizing cavity is essentially aligned with the ejection element in the pressing direction, wherein the method further comprises the step: equalizing pressure exerted onto the cellulose blank structure by the ejection element upon forming of the cellulose products in the forming mould.

24. (canceled)
